(19) United States
(12) Patent Application Publication
(10) Pub. No.: US 2020/0402536 A1
(43) Pub. Date: Dec. 24, 2020

(54) COLLABORATIVE AUDIO EDITING TOOLS

(71) Applicant: Musico Ltd., Ramat-HaSharon (IL)

(72) Inventors: Jhonatan Oved Eliyahu PISTINER, Tel-Aviv (IL); Barak Daniel INBAR, Ramat-HaSharon (IL); Eyal COHEN, Shoham (IL)

(73) Assignee: Musico Ltd., Ramat-HaSharon (IL)

(21) Appl. No.: 16/762,947

(22) PCT Filed: Nov. 12, 2018
(86) PCT No.: PCT/IL2018/051219

§ 371 Date: May 11, 2020

Related U.S. Application Data
(60) Provisional application No. 62/584,830, filed on Nov. 12, 2017.

(51) Int. Cl. G11B 27/031; G11B 27/10; G06F 3/0482; H04L 29/08

(52) U.S. Cl. CPC G11B 27/031; H04L 67/06; G06F 3/0482; G11B 27/10

(57) ABSTRACT

A method for multi-track file sharing and editing, comprising receiving from client devices audio records documenting audio tracks of a multi-track project, upon receiving at least one of the audio records: performing a temporal synchronization of a respective the audio record with previously received audio tracks, updating an interactive graphical interface that includes concentric track control elements to share the common center with the respective concentric control element and to reflect the temporal synchronization, each of the plurality of concentric control elements has bar elements arranged in a sequence and associated with a the audio segments of one of the audio tracks, identifying at least one user selection indicative of a group of the audio segments of one of the bar elements, and editing the group of the audio segments according to user editing instructions.

### BACKGROUND

The present invention, in some embodiments thereof, relates to cooperative music creation and, more specifically, but not exclusively, to a system that enable remote users to create music together in an asynchronous manner.

Music making is often a collaborative effort among many musicians who interact with each other. During the last years various online solutions have been developed to allow creators to share music projects with other creators and to collaborate with the global community. These online solutions allow creators to pull music projects from others to remix, add to and learn from.

### SUMMARY

According to some embodiments of the present invention there is provided a computer-implemented method for multi-track file sharing and editing. The method comprises receiving from a plurality of client devices a plurality of audio records documenting a plurality of audio tracks of a multi-track project, upon receiving at least one of the plurality of audio records: performing a temporal synchronization of a respective the audio record with previously received audio tracks from the plurality of audio tracks, updating an interactive graphical interface that includes a plurality of concentric track control elements, each associated with one of the previously received audio tracks, to share a common center with the respective concentric control element and to reflect the temporal synchronization, each of the plurality of concentric control elements has a plurality of bar elements arranged in a sequence and associated with a plurality of audio segments of one of the plurality of audio tracks, identifying at least one user selection indicative of a group of the plurality of audio segments of one of the plurality of bar elements, and editing the group of the plurality of audio segments according to user editing instructions.

Optionally, the temporal synchronization is performed by calculating scores each for one of a plurality of possible temporal changes to the respective audio record and selecting one of the plurality of possible temporal changes according to the scores.

More optionally, the calculating is performed according to at least some members of the following group: a length, a musical instrument type, a temporal length, a beat rate, an estimated noise, and poly/mono pony.

Optionally, the plurality of audio tracks are received in a non-synchronic manner from the plurality of client devices.

Optionally, each of the plurality of concentric track control elements is aligned in an annular grid sharing the common center with other annular grids each aligned with one of the plurality of concentric track control elements.

Optionally, the at least one user selection is performed by a first user; further comprising forwarding a reference to the group to a second user; wherein the user editing instructions are received from a client device used by the second user.

More optionally, the reference is forwarded in association with textual input received from the first user on an instant messaging platform.

Optionally, a number of the bar elements is set automatically according to a beat rate defined for the multi-track project.

According to some embodiments of the present invention there is provided a system for multi-track file sharing and editing. The system comprises a network interface for receiving over a network a plurality of audio records documenting a plurality of audio tracks of a multi-track project from a plurality of client devices, at least one processor for performing the following upon receiving at least one of the plurality of audio records: performing a temporal synchronization of a respective the audio record with previously received audio tracks from the plurality of audio tracks, updating an interactive graphical interface that includes a plurality of concentric track control elements sharing a common center, each associated with one of the previously received audio tracks, to share a common center with the respective concentric control element and to reflect the temporal synchronization, each of the plurality of concentric control elements has a plurality of bar elements arranged in a sequence and associated with a plurality of audio segments of one of the plurality of audio tracks, receiving from one of the plurality of client devices at least one user selection indicative of a group of the plurality of audio segments of one of the plurality of bar elements, and editing the group of the plurality of audio segments according to user editing instructions.

Optionally, the at least one user selection comprises a plurality of user selections and the user editing instructions are received from at least some of plurality of client devices when used by different users.

According to some embodiments of the present invention there is provided a client device for multi-track file sharing and editing. The client device comprises a display, a network interface for transmitting over a network to a remote server at least one of a plurality of audio records documenting a plurality of audio tracks of a multi-track project to be allow performing a temporal synchronization of the at least one respective audio record with previously received audio tracks from the plurality of audio tracks, at least one processor for performing the following: updating a presentation of interactive graphical interface on the display, the interactive graphical interface includes a plurality of concentric track control elements sharing a common center, each associated with one of the previously received audio tracks, the plurality of concentric track control elements share a common center and reflects the temporal synchronization, each of the plurality of concentric control elements has a plurality of bar elements arranged in a sequence and associated with a plurality of audio segments of one of the plurality of audio tracks, identify at least one user selection indicative of a group of the plurality of audio segments of one of the plurality of bar elements, and instruct editing the group of the plurality of audio segments according to user editing instructions.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 a flowchart of a method of collaborative editing of a multi-track project, according to some embodiments of the present invention;

FIG. 2 is a schematic illustration of a network, a server system 200 and client devices such as mobile devices, according to some embodiments of the present invention;

FIGS. 3A-3C are exemplary screenshots of a graphical user interface, according to some embodiments of the present invention;

FIGS. 4A-4B are exemplary screenshots of an ellipsoid graphical user interface, according to some embodiments of the present invention; and

FIGS. 5A-5B are exemplary screenshots of a rectangular graphical user interface, according to some embodiments of the present invention.

### DETAILED DESCRIPTION

The present invention, in some embodiments thereof, relates to cooperative music creation and, more specifically, but not exclusively, to a system that enable remote users to create music together in an asynchronous manner.

According to some embodiments of the present invention, there are provided methods and systems for collaborative editing of a multi-track project (e.g. music file) by different users who uses different client devices, optionally in a non-synchronic manner. The methods and systems are based on a graphical user interface that improves the speed, accuracy and usability of the editing by temporally synchronized audio tracks and representing segments of these audio tracks in concentric track control elements which share a common center. Each audio track control has multiple bar elements. Each bar element represents one of the segments of one of the audio track. The bar elements are arranged in a sequence, optionally in one of a plurality of circular grids in which the control track elements are placed. Each segment is optionally a beat long and bar elements sharing a common radial are associated with segments which are to be played at the same time (e.g. at a certain beat). In such a manner the user can easily probe which segments of which audio tracks are set to be played together.

Optionally, users can select groups of segments and either edit them (e.g. replacing them with others) and/or forward and/or mark them for editing by other users.

For example, methods and systems may provide a chat platform (e.g. instant messaging system) that allows different users to discuss about selected segments while the track control elements which are indicative of track synchronization are presented to them. As the GUI presents the location of a selected group of segments in relation to other segments of other audio track to all members of the chat, a clear discussion regarding the segments can be developed without requiring any of the users to indicate time or bar coordinates in a text message.

Optionally, the number of grids and/or the beat length is automatically adapted according to changes to the multi-track file by any of the users.

Optionally, the audio tracks are automatically synchronized in the time domain based on signal analysis.

Optionally, the GUI is rendered at displays of different client devices according to instructions or data received from a server system which is connected to a network. The GUI is displayed (e.g. rendered) according to instructions from a client module executed on the client device, for example a code executed using a browser or an application installed on the client device. The display may be instructed from a server defined for example as described below.

The methods and systems of the present invention allow tracking changes in an audio file and coordinating work on those files among multiple people. It may be used for media management in the process of music creation and/or to keep track of changes in any set of audio files. The methods and systems may be used for providing a distributed revision control solution aimed at speed, data integrity, and support for distributed, non-linear workflows as described below. The methods and systems allows musicians and producers to manage work worldwide, regardless of their geographic location and/or work frame time.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

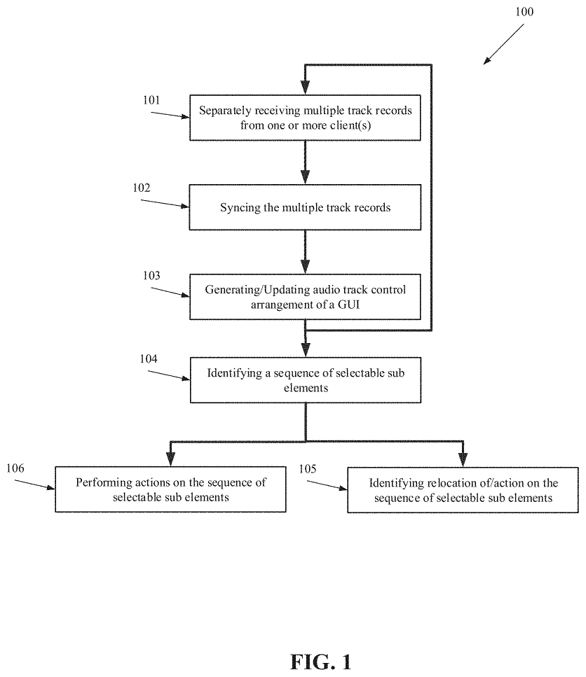

Reference is now made to FIG. 1, which is a flowchart 100 of a method of collaborative editing of a multi-track project, for instance a multi-track audio file, such as a song file having various audio tracks such as vocals, guitars, drums, according to some embodiments of the present invention. The multi-track audio file may be in a multi-track audio format such as stems.

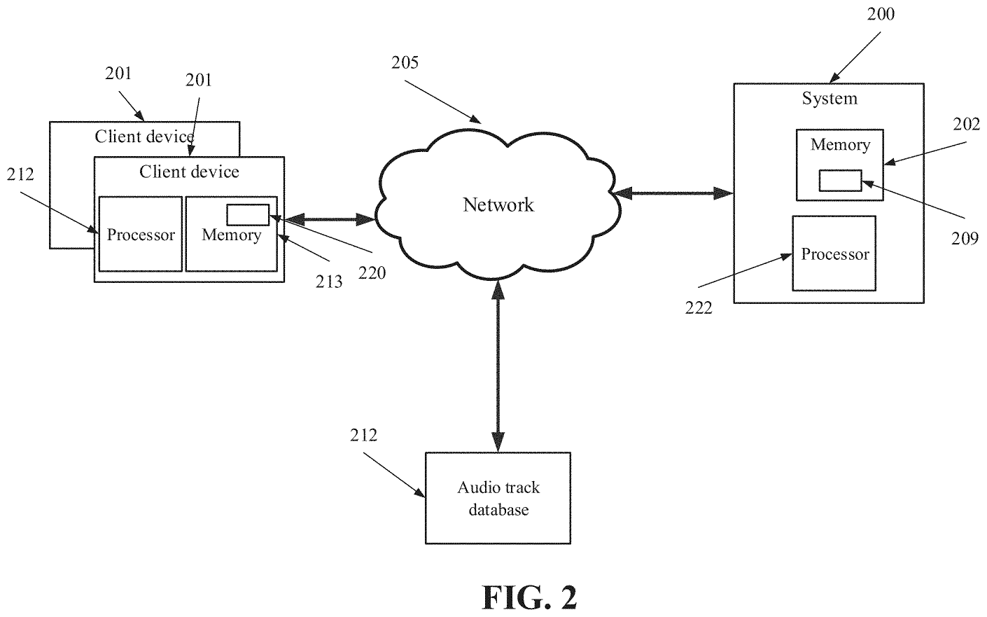

Reference is also made to FIG. 2, which is a schematic illustration of a network 205, a server system 200 and client devices 201 such as mobile devices, for example smartphones, tablets, and/or laptops, according to some embodiments of the present invention. The server system 200 has or connected to an audio track database 212 and has a memory 202 hosting a code 209 such as an application code and one or more processor(s) 222 that executes the code for implementing a method such as method 100. While the description herein related to an execution of the code on the processor(s) 222, some or all of the features of the code may be executed remotely on one or more servers or by processors 212 and code stored on memories 213 of the client device(s) 201, for instance by virtual machine executed remotely and/or by distributed processing methodologies. Each client device 201 executes a client application 220. The client application may be a web service or a code executed using a browser running on the client device 201 and/or an application installed in the client device, for instance an App Store™ or Play Store™ application.

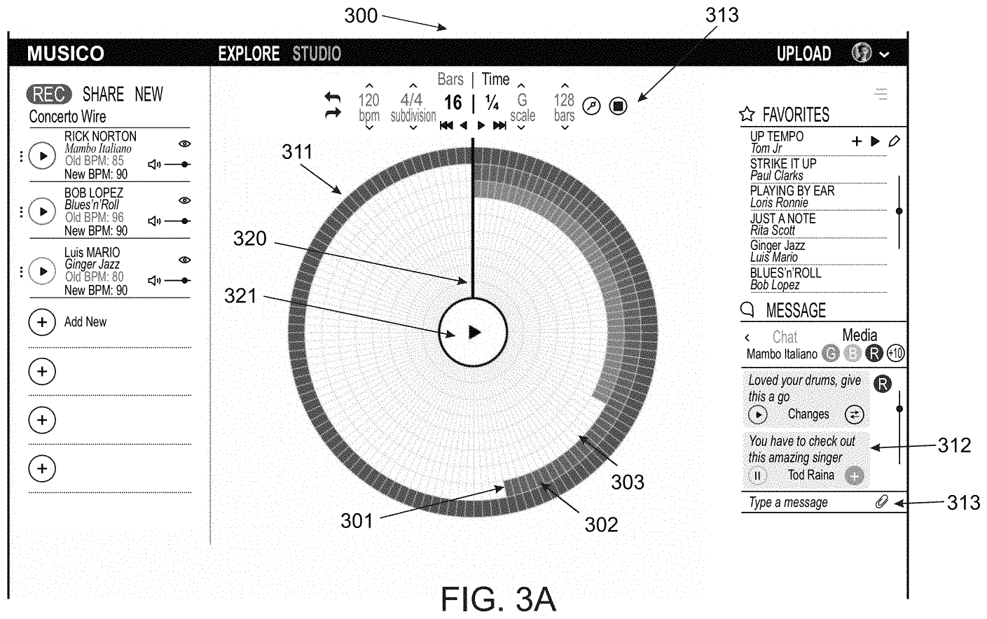

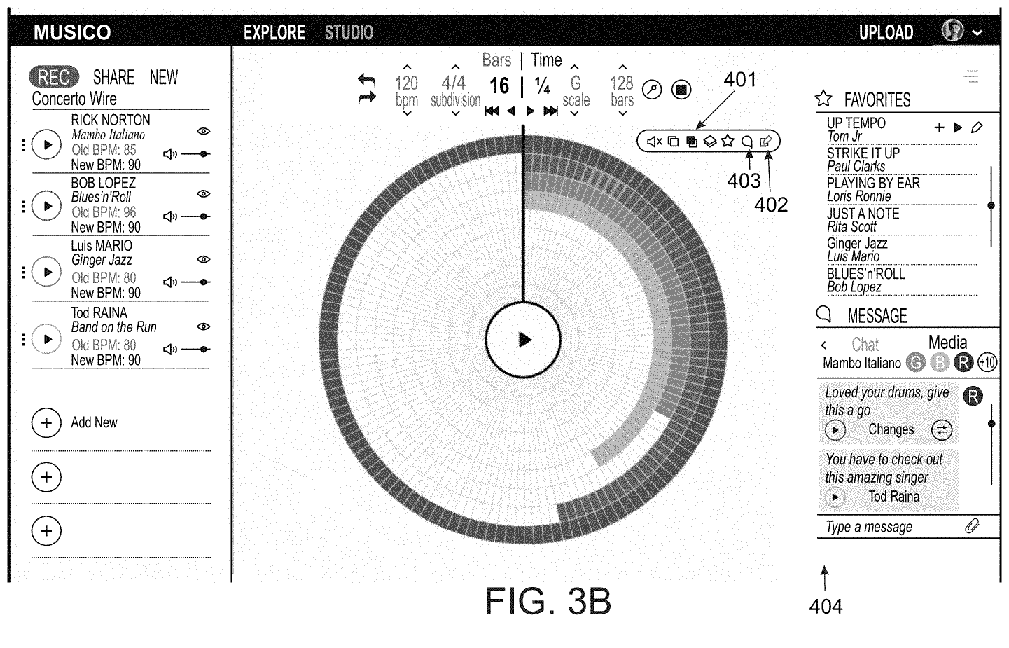

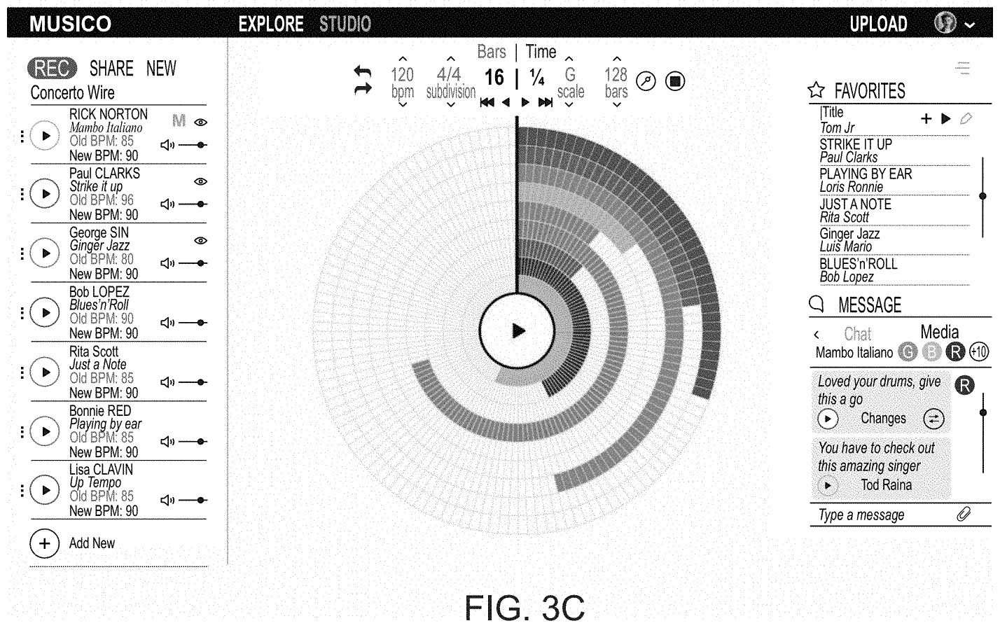

The method 100 and/or system 200 generate a graphical user interface (GUI) for facilitating collaborative editing, such as the GUI 300 depicted in FIG. 3A. The GUI 300 includes an audio track control arrangement 311, optionally circular, that depicts temporal synchronization among tracks of a multi-track audio file or project and allows multiple users to edit some or all of the segment(s) of any of the tracks of the multi-track audio file or project. Each track of the multi-track audio file is represented in the GUI by a track control element. Optionally, the audio track control arrangement 311 includes a plurality of concentric track control elements. The concentric track control elements, may be annular or shaped along an outline of any closed line shape (e.g. rectangular, triangular and/or semi or fully curved). In such embodiments, each of the track control elements is optionally annular and shares a common center with other track control elements of the track control arrangement 311. A track is an audio track created by a single music tool or a virtual representation thereof, for instance drums, guitar, singing, bass, piano and/or the like. The track control element has selectable bar elements, optionally sequentially arranged in a grid, optionally concentric are depicted in FIGS. 3A-3C. The number of grid slots is optionally dynamically adapted to the beat rate of the multi-track project. The number of grids is optionally adapted according to the number of uploaded audio tracks.

Each bar element is associated with a segment of time, referred to as a bar or a measure, corresponding to a specific number of beats (e.g. 2, 4, 8 and 16). The location of a bar element of one track in relation to bar elements of other track(s) emphasizes the temporal differences between the segments they represent, allowing the user to manually adjust temporal synchronization of the segments by relocating the bar elements along a grid of the track control element, optionally an annular grid. For example, bar elements in different annular grids (e.g. concentric) of different track control elements along a common radial from the shared center are associated with segments which share a common playing time when the creation defined by the track control arrangement 311 is played. In such embodiments, each radial represents a group of segments of different tracks which are set to be played simultaneously.

Optionally, any sequence of bar elements may be marked for selection by a user, for instance by a finger gesture or a mouse pointer hoovering. Any sequence of bar elements may be copied for storage, editing and/or sharing with one or more other users of the system 200. The sharing may be performed by forwarding a copy (e.g. a file) or a reference (e.g. a location reference such as a track and segment identifiers) to the selected segments using a messaging platform such as an instant messaging (IM) platform that is integrated into the GUI as described below. The sharing may be done while allowing the sending user to input his thoughts or requests in association with the shared sequence. The sharing allows other users to edit segments and/or replace them while receiving a clear indication about their temporal synchronization with other segments. Such a GUI increases the speed and accuracy of the collaborative editing of the multi-track file as it allows different users to edit tracks, share ideas about segments, and/or suggest synchronization between segments of different tracks by simple user selections such as finger gesture(s) (e.g. touch or swipe) and/or single mouse maneuver(s) (e.g. mouse click or hoover).

In the embodiments wherein the track control elements are concentric, when playing the multi-track file defined in the audio track control arrangement 311 represented in the GUI, a dial 320 is rotated along the concentric track control elements. The playing is optionally timed with a beat per minute (BPM) rate selected from the respective multi-track file. Playing may be initiated and/or stopped when button 321 is selected.

The audio track control arrangement 311 increase the speed and accuracy of the collaborative editing of a music piece, allowing various contributors to adjust the synchronization between different audio tracks and to discuss about various segments of the audio tracks as described below. The described GUI allow users to select segments by simple maneuvers, see the synchronization of all the tracks in a common display and the effect of any temporal relocation of one track in relation to the other. The GUI is connected to the tracks stored on the respective project or file, allowing performing changes in manner that cannot be done manually or by using existing music editing systems or methods. Furthermore, BPM and other features can be easily reviewed and/or adjusted.

Reference is now made to the flow described in FIG. 1.

As shown at 101, the server system 200 receives, via network 205, a plurality of audio records from one or more client terminals of one or more users. Optionally, the audio records are uploaded in a non-synchronic manner from different client devices 201 or the same client device 201. The audio records are documented in a multi-track file or project. Each record is uploaded using one of the client applications 220 which are executed by the different client devices 201, for example mobile devices or laptops of different users which are remotely located from one another, for instance located in different streets, cities, countries and/or the like. In use, a user may use the client application 220 for designating an audio track he recorded, for instance by selecting an audio track (e.g. a file) and/or recording a new audio track using a virtual music tool connected to the client application 220 and/or a microphone of or connected to the client device 201. The audio tracks may be created using a Digital audio workstation (DAW) application such as Music Studio™. An audio record may be extracted from an initial audio record documenting a plurality of audio tracks by automatically isolating one of the audio tracks, for instance by using existing audio source separation software.

The uploaded audio tracks are optionally stored in the audio track database 212 (e.g. central or distributed database), for instance in a multi-track file (e.g. in stem protocol) created for a project on which a plurality of users work collaboratively. For example, a project may be a music piece created by a plurality of users who collaborate using the system 200 by editing audio tracks of one another and/or by uploading new audio tracks.

Now, as shown at 102, the code 209, when executed, temporally synchronizes between the audio tracks (in the temporal space). Reference is not made to an exemplary synchronization methodology. As indicated above, the audio tracks may be added in a non-synchronized manner. In such embodiments, any added audio track is synchronized with the previously uploaded audio tracks, for example automatically when added and/or in response to a user selection.

Optionally, upon uploading a track or after, the code 209 executes a process for identifying a number of track parameters of the track by analyzing the received track and/or extracting the track parameters from metadata associated therewith. The track parameters include a length, a musical instrument type, a temporal length, BPM, estimated noise (e.g. sound to noise ratio), and/or a poly/mono pony. For brevity, ti denoted a musical instrument type, II denoted a temporal length, ti denotes a musical instrument type, bi denoted BPM, ni denoted estimated noise, and/or pi denoted a poly/mono pony (e.g. binary value), si denotes a standard deviation of an average of peaks, BPMt denotes a target BPM.

For each audio track a score (e.g. rank, score or weight) is given for a number of possible temporal relocations in relation to the other uploaded audio tracks (when applicable). For example, the score is calculated as follows:

$${f}_{{t}_{i}} ( B P {M}_{t} ) = 1 - \frac{1}{{( B P {M}_{t} - {b}_{i} )}^{{t}_{i}}}$$

Optionally, noise is taken into account as follows:

$${f}_{l i n i} ( B P {M}_{t} ) = 1 - \frac{1}{{( B P {M}_{i} - {b}_{i} )}^{{l}_{i} - {n}_{i}}}$$

Optionally, si and pi are taken into account as follows:

$${f}_{{p}_{i}} ( B P {M}_{t} ) = \{ \begin{matrix}{p}_{i} = 1 ⋂ {s}_{i} < 10 ; 0 \\ {p}_{i} = 0 ⋂ {s}_{i} < 10 ; 0.1 \\ {p}_{i} = 0 ⋂ {s}_{i} > 10 ; 0.5 \\ {p}_{i} = 1 ⋂ {s}_{i} > 10 ; 1\end{matrix}$$

and the outcome of all the functions is summed as follows:

fi(BPMₜ)=fₜᵢ+fₗᵢₙᵢ+fₚᵢ

This allows calculating a total score for each relocation (e.g. temporal change) BMPt as follows:

$$f ( b p {m}_{t} ) = {\sum }_{i = 1}^{n} {f}_{i} ( B P {M}_{t} )$$

where identifying a minimum for f(BPMₜ) is set as a target, namely the BPMₜ giving min fₓ, for instance using Branch and bound process as described in: www(dot)en(dot)wikipedia(dot)org/wiki/Constrained_optimization.

Alternatively, the synchronization may be performed as described in Kammerl e.t al, TEMPORAL SYNCHRONIZATION OF MULTIPLE AUDIO SIGNALS, Acoustics, Speech and Signal Processing (ICASSP), 2014 IEEE International Conference on 4-9 May 2014.

This allows, as shown at 103, generating or updating an audio track control arrangement of an interactive graphical interface (GUI) (e.g. 311) to include a plurality of control elements each associated with one of the received plurality of audio tracks and arranged to depict the temporal synchronization with other audio tracks. Optionally, as indicated above, the control elements are concentric control elements sharing a common center and optionally arranged in annular grids.

The GUI may be rendered on the display of any of the client device 201 according to instructions from the client application 220. For example, the GUI is presented in a webpage or an application based on data acquired from the respective multi track file. The GUI may be presented to each one of the users who is registered to the multi-track file or project, for instance a creation group or a band. The registration may be performed using a service executed by the server system 200.

Each one of the track control elements has a plurality of bar elements arranged in a sequence, optionally in a grid, and associated with a plurality of audio segments of respective the audio track. For example FIG. 3A is a screenshot of an exemplary GUI 300 that has an audio track control arrangement 311 with a plurality of control elements 301 each associated with an audio track. In this example, the control element is an annular control element 301 having a plurality of bar elements 302 which are associated with plurality of audio segments, bars, of the audio track and arranged along the annular control element.

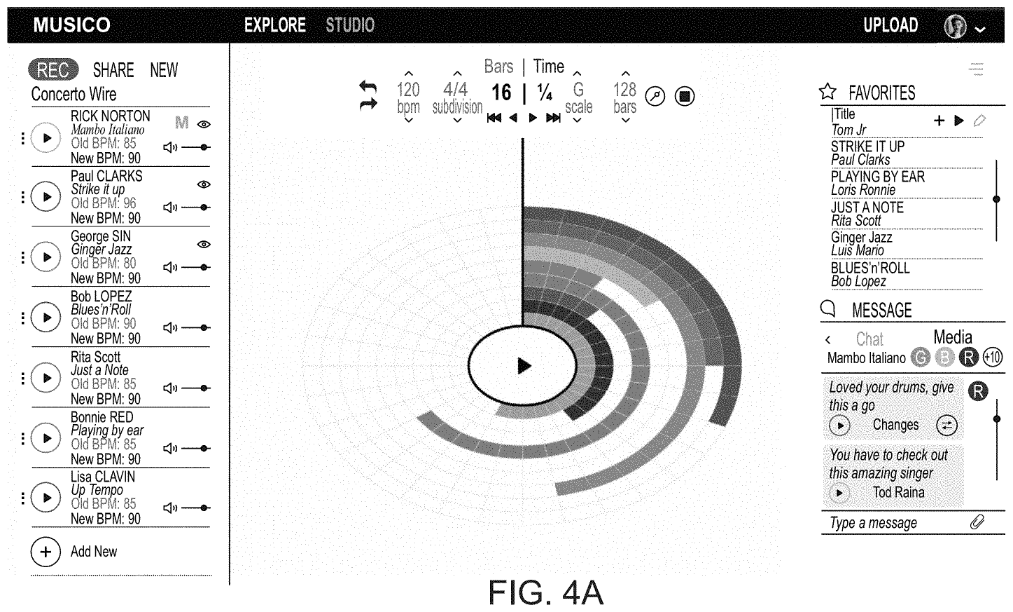

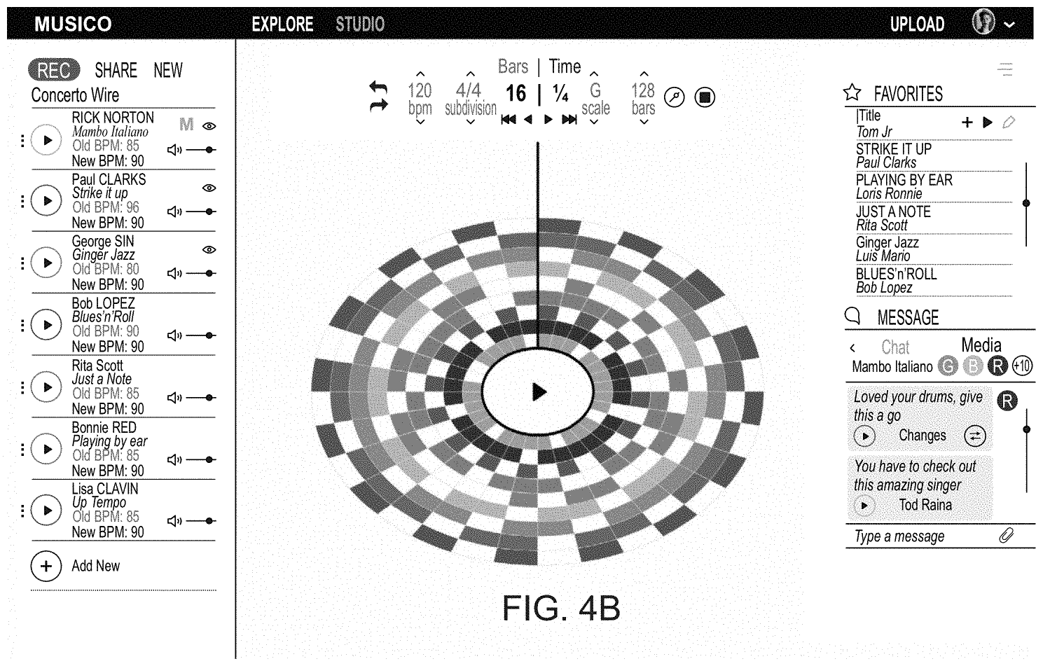

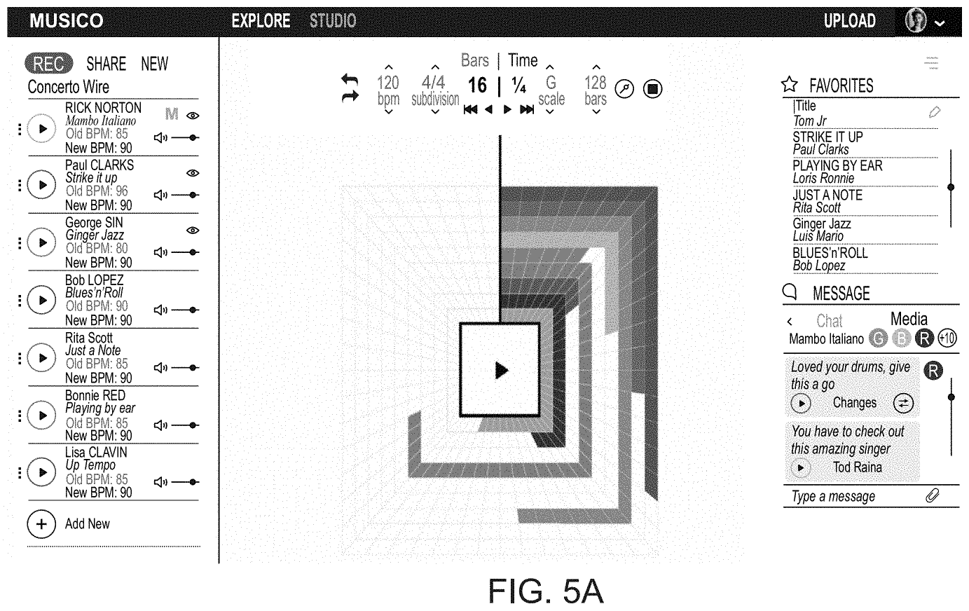

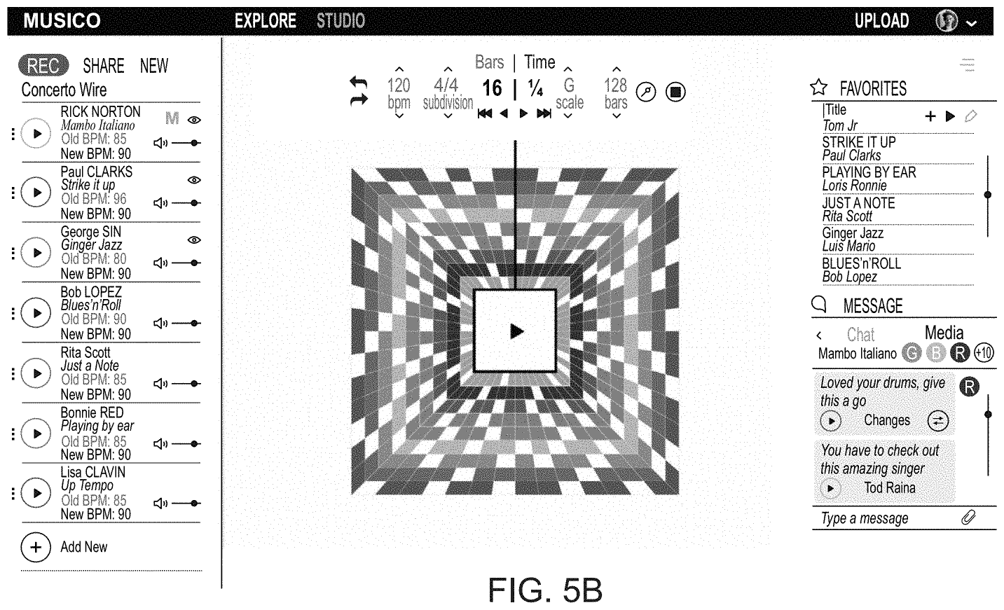

Optionally, track control elements 301 of audio tracks are radially arranged according to temporal length (e.g. the longest is the most remote from the center of a parabolic object such as a circle or a parabola, defined by the audio track control arrangement 311). Alternatively, the track control elements are arranged according to their addition order (e.g. the first one added is the most remote from the center of a circle defined by the audio track control arrangement). The track control elements may be arranged to have a common center. For example, in FIGS. 4A-4B the track control elements are part of an ellipsoid graphical user interface and in FIGS. 5A-5B they are part of a rectangular graphical user interface.

The bar elements 302 are arranged annularly (e.g. in a circle, square or any other shape that share a common center with other control elements) such that each bar element is located between two other bar elements. Optionally, some or all of the bar elements are placed in slots of a grid, such as 303, created according to a selected beat per minute (BPM). The number of slots per grid of a control element may be adjusted by the user, for instance by selecting a desired BPM for the multi-track file as a whole. For example, 120 BPM for a multi-track file of 120 seconds with a 4 beats per bar ratio (also referred to as subdivision) creates 60 slots per control element. In another example, 180 BPM for a multi-track file of 240 seconds with a 4 beats subdivision creates 180 slots per control element. Based on synchronization between the audio tracks, some of the slots are filled with bar elements 302. The location of a bar element associated with one segment of one audio track together with a bar element associated with a second segment of a second audio track along a common column 304 of audio tracks arrangement indicates a synchronization therebetween in the temporal space.

In use, as shown at 104, user selection(s) of a sequence of bar elements of one of the audio tracks. The user selections are identified using an application executed on the client device, for instance the client application 220, and indicative of a selected sequence of segments. A selection of one of the control elements 301 by a mouse clicks or a touch event or a marker hoover may emphasize the selected control element 301 over others. When the control element is annular, the selected from may form

As shown at 105, user selections relocating the selected sequence of segments from a set of slots of one of the control elements to other set of slots of the control elements are identified. The user selections may be converted or otherwise used for generating synchronization instructions for resynchronizing the selected sequence of segments with the other audio tracks. For example, the user may move the selected sequence one or more slots to the right or to the left.

Additionally or alternatively, as shown at 106, the selected sequence may be marked for performing actions. For example, reference numeral 401 in FIG. 3B is an exemplary row of icons for performing actions on the selected sequence.

When 402 is selected, the selected sequence may be added to a favorite folder. This allows adding the selected sequence to other multi-track files and/or editing it separately.

When 403 is selected, sending/forwarding the selected sequence to one of the users for editing or review may be performed. The selected sequence may be forwarded as a file and/or a link to the selected sequence at the multi-track file. The selected sequence may be forwarded or otherwise indicated as a part of message, such as an IM message, for instance as depicted by 312 of FIG. 3A. An edited version of the selected sequence may be received and automatically placed to replace the selected sequence, for instance when the user selects a designated button, such as 313.

In use, by sending the selected sequence to another user, the receiving user can edit the selected sequence and upload it back to the multi-track file and/or send it back for approval/review. This may be done by using a location indicator, replacing segments in a synchronized manner.

When 404 is selected, a swap action is executed, the selected sequence is replaced with a new sequence, for instance a new file or recording. This allows creating a new sequence which is better synchronized or tuned with the respective temporally correlated segments of the other audio tracks. Clearly actions triggered by 402-404 can be triggered by any other user interface.

When referring to FIG. 3A a number of additional actions may be facilitated. For example, 313 is an exemplary row of possible actions for assisting in editing a multi-track file presented by the track control arrangement 311 as a whole. From left to right, UNDO\REDO buttons are provided to undo or redo previous actions, BPM button to change the BPM of the multi-track file, subdivision button to change the Subdivision presented in the track control arrangement 311, a Counter\Timer button presenting the number of beats per bar, a scale button for adapting the scale of the multi-track file, a Bars button for adapting the number of bars in the multi-track file and/or for adding bars (e.g. slots) to the multi-track file, a Metronome button for adding a Metronome track to the track control arrangement 311 and a Grid on\off for removing or adding the presentation of slots in the GUI.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a display, a client, a server system and a GUI is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer-implemented method for multi-track file sharing and editing, comprising:
receiving from a plurality of client devices a plurality of audio records documenting a plurality of audio tracks of a multi-track project;
upon receiving at least one of the plurality of audio records:
performing a temporal synchronization of a respective the audio record with previously received audio tracks from the plurality of audio tracks;
updating an interactive graphical interface that includes a plurality of concentric track control elements, each associated with one of the previously received audio tracks, to share a common center with the respective concentric control element and to reflect the temporal synchronization, each of the plurality of concentric control elements has a plurality of bar elements arranged in a sequence and associated with a plurality of audio segments of one of the plurality of audio tracks;
identifying at least one user selection indicative of a group of the plurality of audio segments of one of the plurality of bar elements; and
editing the group of the plurality of audio segments according to user editing instructions.

2. The computer-implemented method of claim 1, wherein the temporal synchronization is performed by calculating scores each for one of a plurality of possible temporal changes to the respective audio record and selecting one of the plurality of possible temporal changes according to the scores.

3. The computer-implemented method of claim 2, wherein the calculating is performed according to at least some members of the following group: a length, a musical instrument type, a temporal length, a beat rate, an estimated noise, and poly/mono pony.

4. The computer-implemented method of claim 1, wherein the plurality of audio tracks are received in a non-synchronic manner from the plurality of client devices.

5. The computer-implemented method of claim 1, wherein each of the plurality of concentric track control elements is aligned in an annular grid sharing the common center with other annular grids each aligned with one of the plurality of concentric track control elements.

6. The computer-implemented method of claim 1, wherein the at least one user selection is performed by a first user; further comprising forwarding a reference to the group to a second user; wherein the user editing instructions are received from a client device used by the second user.

7. The computer-implemented method of claim 6, wherein the reference is forwarded in association with textual input received from the first user on an instant messaging platform.

8. The computer-implemented method of claim 1, wherein a number of the bar elements is set automatically according to a beat rate defined for the multi-track project.

9. A system for multi-track file sharing and editing, comprising:
a network interface for receiving over a network a plurality of audio records documenting a plurality of audio tracks of a multi-track project from a plurality of client devices;
at least one processor for performing the following upon receiving at least one of the plurality of audio records:
performing a temporal synchronization of a respective the audio record with previously received audio tracks from the plurality of audio tracks;
updating an interactive graphical interface that includes a plurality of concentric track control elements sharing a common center, each associated with one of the previously received audio tracks, to share a common center with the respective concentric control element and to reflect the temporal synchronization, each of the plurality of concentric control elements has a plurality of bar elements arranged in a sequence and associated with a plurality of audio segments of one of the plurality of audio tracks;
receiving from one of the plurality of client devices at least one user selection indicative of a group of the plurality of audio segments of one of the plurality of bar elements; and
editing the group of the plurality of audio segments according to user editing instructions.

10. The system of claim 9, wherein the at least one user selection comprises a plurality of user selections and the user editing instructions are received from at least some of plurality of client devices when used by different users.

11. A client device for multi-track file sharing and editing, comprising:
a display;
a network interface for transmitting over a network to a remote server at least one of a plurality of audio records documenting a plurality of audio tracks of a multi-track project to be allow performing a temporal synchronization of the at least one respective audio record with previously received audio tracks from the plurality of audio tracks;
at least one processor for performing the following:
updating a presentation of interactive graphical interface on the display, the interactive graphical interface includes a plurality of concentric track control elements sharing a common center, each associated with one of the previously received audio tracks, the plurality of concentric track control elements share a common center and reflects the temporal synchronization, each of the plurality of concentric control elements has a plurality of bar elements arranged in a sequence and associated with a plurality of audio segments of one of the plurality of audio tracks;
identify at least one user selection indicative of a group of the plurality of audio segments of one of the plurality of bar elements; and
instruct editing the group of the plurality of audio segments according to user editing instructions.
